(19) United States
(12) Patent Application Publication
(10) Pub. No.: US 2020/0132922 A1
(43) Pub. Date: Apr. 30, 2020

(54) BACKLIGHT MODULE AND NARROW-BEZEL LIQUID CRYSTAL DISPLAY MODULE

(71) Applicant: WUHAN CHINA STAR OPTOELECTRONICS TECHNOLOGY CO., LTD., Wuhan, Hubei (CN)

(72) Inventor: Wei ZHANG, Wuhan, Hubei (CN)

(21) Appl. No.: 16/463,782

(22) PCT Filed: Nov. 22, 2018
(86) PCT No.: PCT/CN2018/117046

§ 371 Date: May 23, 2019

(30) Foreign Application Priority Data
Oct. 30, 2018 (CN) 201811280977.8

(51) Int. Cl. F21V 8/00

(52) U.S. Cl. CPC G02B 6/0088; G02B 6/0055

(57) ABSTRACT

A backlight module and a narrow-bezel liquid crystal display (LCD) module are provided. The backlight module includes a back plate. The back plate includes a bottom plate, a side plate connected to an edge of the bottom plate, and a bent portion connected to the side plate. The bent portion is used to be bonded to the LCD panel through a sealing material. The strength of the backlight module can be enhanced and a width of the sealing material can be reduced, thereby realizing a narrow bezel of the LCD module. In addition, the back plate structure can further lower the risk of the sealing material spilling into the backlight module.

### FIELD OF INVENTION

The present invention relates to the field of display technologies, and in particular, to a backlight module and a narrow-bezel liquid crystal display (LCD) module.

### BACKGROUND OF INVENTION

A thin film transistor (TFT) is a main driving element in the current LCD and active matrix organic light-emitting diode (AMOLED), and directly affects display performance of panel display devices.

Most LCDs on the current market are backlight-type LCDs. A backlight-type LCD includes an LCD panel and a backlight module. A working principle of the LCD panel is as follows: pouring liquid crystal molecules between a thin film transistor array substrate (TFT array substrate) and a color filter (CF) substrate, and applying a pixel voltage and a common voltage on the two substrates respectively. A rotation direction of the liquid crystal molecules is controlled by using an electric field formed between the pixel voltage and the common voltage, so that light of the backlight module is transmitted out to generate an image.

On the current backlight module, a black-white double-sided square sealing material or a black-black double-sided square sealing material is adhered onto a plastic frame to connect the LCD panel and the backlight module and prevent displacement of a film. Besides, the square sealing material is further used for covering gaps between the plastic frame and the light guide plate and between the plastic frame and an optical film in the backlight module, so as to prevent light leakage.

To prevent displacement of the film, an inner ring of a ring structure of the square sealing material should extend onto the optical film, and a width of a part of the square sealing material on the optical film should meet a particular requirement. Moreover, the square sealing material should be attached to the plastic frame and has certain stability. Therefore, the plastic frame also requires a sufficient width to ensure the attaching strength. The width of the plastic frame of the backlight module is greater than a width of the LCD panel, and therefore a minimum width of the plastic frame should also meet a requirement.

A mass-production extreme value of the current square sealing material located on two sides of the plastic frame is 0.45 mm. As the bezel of the current LCD module becomes increasingly narrower, a width of the square sealing material located on two sides of the plastic frame is already less than the mass-production extreme value of 0.45 mm. For example, when the bezel of the LCD module is 0.6 mm, the width of the square sealing material located on two sides of the plastic frame is 0.3 mm. As a result, it is extremely difficult to process and attach the square sealing material in the current narrow-bezel LCD module.

### SUMMARY OF INVENTION

An objective of the present invention is to provide a backlight module that has high strength and a small sealing material width, so as to realize a narrow bezel of an LCD module.

Another objective of the present invention is to provide a narrow-bezel LCD module, in which a backlight module has high strength, a sealing material has a small width, and a bezel is narrow.

In order to achieve the objectives above, the present invention provides a backlight module, including: a back plate, wherein the back plate includes a bottom plate, a side plate connected to an edge of the bottom plate, and a bent portion connected to the side plate; and the bent portion is configured to be bonded to an LCD panel through a sealing material.

The backlight module further includes a reflector plate disposed on the bottom plate, a light guide plate disposed on the reflector plate, and an optical film set disposed on the light guide plate.

The bent portion is bent towards the bottom plate.

The bent portion includes a first part parallel to the side plate and a second part connected to the first part and the side plate.

The back plate is integrally formed of iron and plastic.

The present invention further provides a narrow-bezel LCD module, including: a backlight module and an LCD panel disposed on the backlight module, wherein the backlight module includes a back plate; the back plate includes a bottom plate, a side plate connected to an edge of the bottom plate, and a bent portion connected to the side plate; and the bent portion is bonded to the LCD panel through a sealing material.

The backlight module further includes a reflector plate disposed on the bottom plate, a light guide plate disposed on the reflector plate, and an optical film set disposed on the light guide plate.

A width of the back plate is less than or equal to a width of the LCD panel, and the back plate is integrally formed of iron and plastic.

The bent portion is bent towards the bottom plate, and the bent portion includes a first part parallel to the side plate and a second part connected to the first part and the side plate.

The sealing material is square-shaped

A width of the sealing material is less than 0.45 mm

The sealing material is an ultraviolet (UV) glue.

The present invention achieves beneficial effects as follows: The backlight module of the present invention includes a back plate. The back plate includes a bottom plate, a side plate connected to an edge of the bottom plate, and a bent portion connected to the side plate. The bent portion is configured to be bonded to the LCD panel through a sealing material. The strength of the backlight module can be enhanced and the width of the sealing material can be reduced, thereby realizing a narrow bezel of the LCD module. In addition, the back plate structure can further lower the risk of the sealing material spilling into the backlight module. In the narrow-bezel LCD module of the present invention, the backlight module has high strength, the width of the sealing material is small, and the bezel is narrow.

### BRIEF DESCRIPTION OF DRAWINGS

Please refer to the following detailed description and accompanying drawings related to the present invention to further understand the features and technical content of the present invention. However, the drawings are merely provided for the reference and illustrative purposes, and are not intended to limit the present invention.

In the drawings,

FIG. 1 is a schematic structural view of a backlight module according to the present invention; and

FIG. 2 is a schematic structural view of a narrow-bezel LCD module according to the present invention.

### DETAILED DESCRIPTION OF PREFERRED EMBODIMENTS

In order to further illustrate the technical means used in the present invention and effects thereof, a detailed description is provided below with reference to preferred embodiments of the present invention and the accompanying drawings thereof.

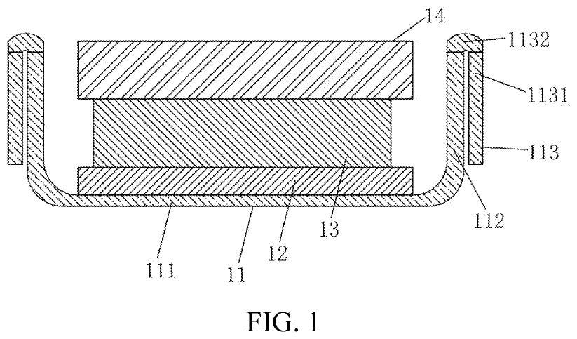

Referring to FIG. 1, the present invention provides a backlight module, including: a back plate 11, wherein the back plate 11 includes a bottom plate 111, a side plate 112 connected to an edge of the bottom plate 111, and a bent portion 113 connected to the side plate 112.

The bent portion 113 is configured to be bonded to a liquid crystal display (LCD) panel 20 through a sealing material 30.

It should be noted that, in the present invention, the back plate 11 of the backlight module 11 includes the bottom plate 111, the side plate 112 connected to the edge of the bottom plate 111, and the bent portion 113 connected to the side plate 112, so that the strength of the backlight module can be enhanced. Moreover, the bent portion 113 can be further bonded to the LCD panel 20 through the sealing material 30 subsequently, thereby reducing a width of the sealing material 30 and realizing a narrow bezel of an LCD module. In addition, the structure of the back plate 11 can further lower the risk of the sealing material 30 spilling into the backlight module.

In details, the backlight module further includes a reflector plate 12 disposed on the bottom plate 111, a light guide plate 13 disposed on the reflector plate 12, and an optical film set 14 disposed on the light guide plate 13.

In detail, the bent portion 113 is bent towards the bottom plate 111.

Further, the bent portion 113 includes a first part 1131 parallel to the side plate 112 and a second part 1132 connected to the first part 1131 and the side plate 112.

In detail, the back plate 11 is integrally formed of iron and plastic.

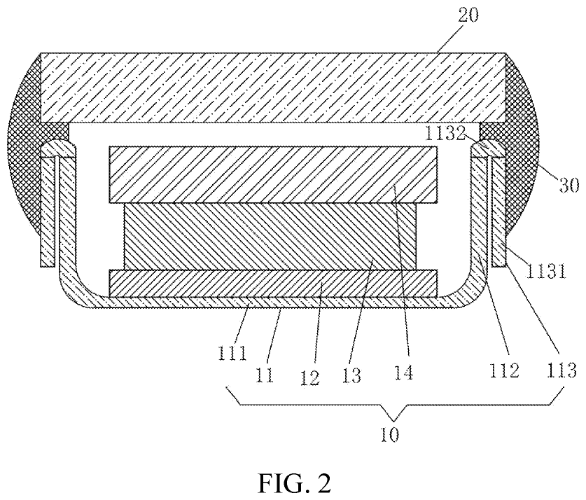

Referring to FIG. 2, based on the backlight module above, the present invention provides a narrow-bezel LCD module, including: a backlight module 10 and an LCD panel 20 disposed on the backlight module 10.

The backlight module 10 includes a back plate 11 bonded to the LCD panel 20, wherein the back plate 11 includes a bottom plate 111, a side plate 112 connected to an edge of the bottom plate 111, and a bent portion 113 connected to the side plate 112.

The bent portion 113 is bonded to the LCD panel 20 through the sealing material 30.

It should be noted that, in the present invention, the back plate 11 of the backlight module 10 includes a bottom plate 111, a side plate 112 connected to an edge of the bottom plate 111, and a bent portion 113 connected to the side plate 112, so that the strength of the backlight module 10 can be enhanced. Moreover, the bent portion 113 can be further bonded to the LCD panel 20 through the sealing material 30, thereby reducing a width of the sealing material 30 and realizing a narrow bezel of the LCD module. In addition, the structure of the back plate 11 can further lower the risk of the sealing material 30 spilling into the backlight module 10.

In detail, the bent portion 113 is bent towards the bottom plate 111.

Further, the bent portion 113 includes a first part 1131 parallel to the side plate 112 and a second part 1132 connected to the first part 1131 and the side plate 112.

In detail, a width of the back plate 11 is less than or equal to a width of the LCD panel 20 (that is, an edge of the back plate 11 is located within the LCD panel 20, or the edge of the back plate 11 coincides with an edge of the LCD panel 20). Because the back plate 11 has the bent portion 13, a lateral side of the bent portion 13 can be bonded to a lateral side of the back plate 11 through the sealing material 30 even if the width of the back plate 11 is less than or equal to the width of the LCD panel 20.

In details, the sealing material 30 is square-shaped. Compared with a conventional square sealing material, the sealing material 30 in the present invention can bond, with a smaller width, the backlight module 10 to the LCD panel 20.

In detail, the width of the sealing material 30 is less than 0.45 mm.

In detail, the sealing material 30 is a UV glue. The LCD module can be formed merely by disposing the UV glue between the bent portion 113 and the LCD panel 20 in the current dispensing manner and curing the UV glue by UV radiation.

In detail, the back plate 11 is integrally formed of iron and plastic.

In detail, the backlight module 10 further includes a reflector plate 12 disposed on the bottom plate 111, a light guide plate 13 disposed on the reflector plate 12, and an optical film set 14 disposed on the light guide plate 13.

In conclusion, the backlight module of the present invention includes a back plate. The back plate includes a bottom plate, a side plate connected to an edge of the bottom plate, and a bent portion connected to the side plate. The bent portion is configured to be bonded to the LCD panel through a sealing material. The strength of the backlight module can be enhanced, and the width of the sealing material can be reduced, thereby realizing a narrow bezel of the LCD module. In addition, the back plate structure can further lower the risk of the sealing material spilling into the backlight module. In the narrow-bezel LCD module of the present invention, the backlight module has high strength, the sealing material has a small width, and the bezel is narrow.

A person of ordinary skill in the art can make various other changes and modifications according to the technical solution and technical concept of the present invention. All the changes and modifications shall fall within the protection scope of the claims of the present invention.

What is claimed is:

1. A backlight module, comprising:
a back plate, wherein the back plate comprises a bottom plate, a side plate connected to an edge of the bottom plate, and a bent portion connected to the side plate; and
wherein the bent portion is configured to be bonded to a liquid crystal display (LCD) panel through a sealing material.

2. The backlight module as claimed in claim 1, further comprising a reflector plate disposed on the bottom plate, a light guide plate disposed on the reflector plate, and an optical film set disposed on the light guide plate.

3. The backlight module as claimed in claim 1, wherein the bent portion is bent towards the bottom plate.

4. The backlight module as claimed in claim 3, wherein the bent portion comprises a first part parallel to the side plate and a second part connected to the first part and the side plate.

5. The backlight module as claimed in claim 1, wherein the back plate is integrally formed of iron and plastic.

6. A narrow-bezel LCD module, comprising:
a backlight module; and
an LCD panel disposed on the backlight module;
wherein the backlight module comprises a back plate; the back plate comprises a bottom plate, a side plate connected to an edge of the bottom plate, and a bent portion connected to the side plate; and the bent portion is bonded to the LCD panel through a sealing material.

7. The narrow-bezel LCD module as claimed in claim 6, wherein the backlight module further comprises a reflector plate disposed on the bottom plate, a light guide plate disposed on the reflector plate, and an optical film set disposed on the light guide plate.

8. The narrow-bezel LCD module as claimed in claim 6, wherein a width of the back plate is less than or equal to a width of the LCD panel; and the back plate is integrally formed of iron and plastic.

9. The narrow-bezel LCD module as claimed in claim 6, wherein the bent portion is bent towards the bottom plate, and the bent portion comprises a first part parallel to the side plate and a second part connected to the first part and the side plate.

10. The narrow-bezel LCD module as claimed in claim 6, wherein the sealing material is square-shaped; a width of the sealing material is less than 0.45 mm, and the sealing material is an ultraviolet (UV) glue.
